(19) United States
(12) Patent Application Publication
(10) Pub. No.: US 2009/0179460 A1
(43) Pub. Date: Jul. 16, 2009

(54) VEHICLE ENGINE COVER

(75) Inventor: Michael N. Peterson, Columbus, OH (US)

Correspondence Address: KREMBLAS, FOSTER, PHILLIPS & POLLICK, 7632 SLATE RIDGE BOULEVARD, REYNOLDSBURG, OH, 43068, US

(73) Assignee: Honda Giken Kogyo Kabushiki Kaisha, Tokyo (JP)

(21) Appl. No.: 12/013,031

(22) Filed: Jan. 11, 2008

(51) Int. Cl. B62D 25/10

(52) U.S. Cl. 296/193.11

(57) ABSTRACT

A one-piece automobile engine cover for protecting vital engine components from external elements such as water and debris. The cover is positioned between the engine and the hood of an automobile and is pivotably attached to the automobile, preferably by the same hinges that attach the hood to the automobile, or by separate, but collinear, hinges. The cover can be latched to the hood to keep it raised for servicing.

### BACKGROUND OF THE INVENTION

1. Field of the Invention

This invention relates generally to automobile engine covers and more particularly to a one-piece automobile engine cover that can be opened and closed in a manner similar to an automobile hood.

2. Description of the Related Art

Traditional automobile engine covers typically consist of several, separate pieces of metal or plastic that clip or bolt to various parts of an engine for protecting vital components from external elements and for reducing the sounds heard outside of the engine compartment. Such covers may also incorporate decorative elements, such as stylistic shaping and manufacturer's emblems for improving the overall appearance of an engine compartment.

In order to perform maintenance on an engine having a traditional, multi-piece cover, a mechanic or other person performing the maintenance must first remove the various cover pieces. This procedure requires time and effort, and often calls for specialized tools. Moreover, adherence to close tolerances is required in the design and fabrication of each of the cover pieces to ensure proper fit, thereby making these pieces costly and time consuming to install.

There is, therefore, the need for a simple, one-piece automobile engine cover that can be quickly and easily removed for gaining access to engine components without the use of tools, and that presents an attractive, uncluttered engine compartment when covering an engine.

### BRIEF SUMMARY OF THE INVENTION

In accordance with the present invention, there is provided a one-piece automobile engine cover for protecting engine components and allowing convenient access. The cover is positioned above an automobile's engine and below an automobile's hood and is preferably fabricated from lightweight, sound-insulating plastic. The cover is preferably pivotably hinged to the automobile about the same hinges that attach the hood to the automobile.

Like an automobile hood, the cover can be pivoted upwardly to a raised, open position and downwardly to a lowered, closed position. In the closed position, the cover seals the engine to reduce the entry of harmful, external elements such as water and debris. In the open position, the cover allows access to the engine for servicing. A releasable latch preferably extends from the bottom of the hood for accepting and temporarily retaining the cover in its open position. Of course, the invention can be used with all automobiles, including but not limited to sedans, trucks, vans, sport utility vehicles and all other motorized vehicles with an engine compartment cover.

### (g) BRIEF DESCRIPTION OF THE SEVERAL VIEWS OF THE DRAWINGS

FIG. 1 is a perspective view illustrating the invention in the closed position.

FIG. 2 is a perspective view illustrating the invention in the opened position.

In describing the preferred embodiment of the invention, which is illustrated in the drawings, specific terminology will be resorted to for the sake of clarity. However, it is not intended that the invention be limited to the specific term so selected and it is to be understood that each specific term includes all technical equivalents that operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

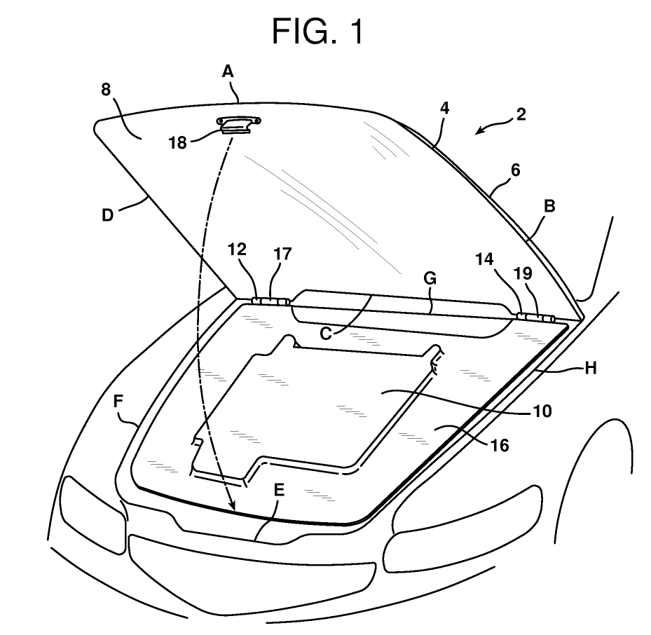

Referring to FIG. 1, the automobile 2 has a conventional hood 4 having a top side 6 (not within view), a bottom side 8, and four adjoining edges: A, B, C, and D. The automobile 2 also has a conventional engine compartment 10 having an upper edge with four sides: E, F, G, and H. An automobile engine is mounted in the compartment 10 in a conventional manner with its upper extremity disposed beneath the bottom side 8 of the hood 4.

The hood 4 is pivotably mounted to the automobile 2 in a conventional manner by hinges 12 and 14. Thus, the hood 4 is able to swing upwardly and downwardly about the hinges 12 and 14 to establish an open hood position or a closed hood position. The hood latches at the side opposite the hinges in a conventional manner. Although the hood 4 is mounted to the automobile 2 adjacent to side G of the engine compartment 10, it is contemplated that the invention is applicable to automobiles having hoods mounted adjacent to any of the sides E, F, or H of an engine compartment. It is also contemplated that the invention is applicable to automobiles having mid and rear-mounted engines and hoods. It will also become apparent that the invention can be used with any automobile, including, but not limited to, sedans, wagons, vans, trucks and sport utility vehicles.

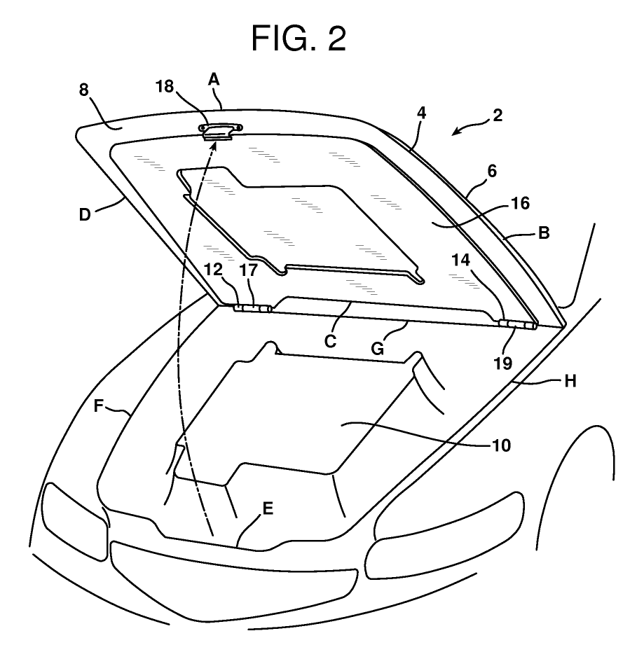

Still referring to FIG. 1, the engine cover 16 is a unitary body, preferably made of a sound insulating plastic or composite, and which preferably conforms to the contour of the top of the engine. Referring to FIG. 2, the cover 16 is preferably similar in shape at its peripheral edges to the hood 4, but is somewhat smaller so that the cover 16 fits within the perimeter of the hood 4. The cover 16 can have a much different peripheral shape than the hood 4, as long as the cover 16 fits within the engine compartment.

The cover 16 is positioned above the engine and below the hood 4, when the hood is in a closed position, and the cover 16 is pivotably mounted to the automobile 2 by hinges 17 and 19, which, in the preferred embodiment, have the same pivot axis as, and are thus collinear with, the pivot axes of the hinges 12 and 14 that attach the hood 4 to the automobile 2. Like the hood 4, the cover 16 is able to swing upwardly and downwardly about its hinges to establish an open cover position (as shown in FIG. 2) or a closed cover position (as shown in FIG. 1).

The cover 16 preferably latches to the engine compartment sidewall by a conventional fastener, so that when the cover 16 is closed, the hood can be raised and lowered independently of the cover 16. The ability to move independently allows the hood 4 to be used in a conventional manner despite the presence of the cover 16. When closed, the cover 16 provides a clean appearance to the engine, preferably still permitting access to some components that automobile operators commonly check, such as washer fluid, brake fluid and/or engine oil. This access can be through small openings (not shown) through the cover 16. Thus, raising and lowering of the cover 16 is an act that is performed, in the normal case, by service personnel. In an alternative embodiment, the cover 16 covers all components, and the operator of the vehicle simply raises and lowers the cover 16 during routine checks of fluids and other engine components.

Referring back to FIG. 1, the cover 16 in the closed position fits securely over and covers the engine so that sounds from the engine and engine component are reduced in intensity before exiting the engine compartment 10. Furthermore, this secure fit reduces the extent to which harmful external elements, such as water and debris, can contact the top of the engine. By concealing the engine and related components, the closed cover 16 also presents a cleaner and less cluttered engine compartment 10.

Referring again to FIG. 2, in order to perform maintenance on the engine, the hood 4 is pivoted away from the engine and placed in the open position. Next, the cover 16 is raised by pivoting it upwardly away from the engine about the hinges 17 and 19. In order to prevent the open cover 16 from falling back to its closed position, the edge of the cover 16 farthest from the hinges 17 and 18 engages a spring-loaded, releasable latch 18 that extends from the bottom side 8 of the hood 4 adjacent to edge A and between edges B and D of the hood. These cooperating structures secure the cover 16 at a fixed distance from the bottom side 8 of the hood 4 and allow a technician to perform service on the engine and related components without interference from the cover 16 and without the need to hold the cover 16 away from the engine manually. Although a spring-loaded latch is the preferred means for retaining the cover in the open position, all other means holding the cover open, such as support brackets, gas struts, and fastening materials such as Velcro, are contemplated. To return the cover 16 to a closed position, the latch 18 is released and the cover 16 pivots downwardly about the hinges 17 and 19. The hood can then be pivoted toward the engine to a closed position. It is contemplated that, in an alternative embodiment, the cover 16 remains latched to the hood 4 when the hood 4 is pivoted toward the engine.

Although it is preferable to fabricate the cover 16 from plastic, all other durable materials are contemplated. The cover 16 must be able to withstand the environmental conditions of the engine compartment, including exposure to significant temperature extremes, chemicals, such as oil and gasoline, and weather extremes. Additionally, while it is preferred that the hood 4 and the cover 16 be attached to the automobile 2 by collinear pairs of hinges, it is contemplated that the cover 16 could be attached to the automobile 2 by a variety of other means, such as clips, latches, pins, fastening materials such as Velcro, or simply by a pair of hinges that are not collinear with those that attach the hood 4 to the automobile 2.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An engine covering apparatus for an automobile having an engine and a hood pivotably attached to the automobile by at least one hood hinge, the apparatus comprising a unitary cover body pivotably attached to the automobile and positioned above the engine and below a bottom side of the hood.

2. The apparatus of claim 1, wherein at least one cover body hinge attaches the cover body to the automobile.

3. The apparatus of claim 2, wherein a pivot axis of said at least one cover body hinge is collinear with a pivot axis of said at least one hood hinge.

4. The apparatus of claim 3, wherein said at least one cover body hinge further comprises two cover body hinges, wherein said at least one hood hinge further comprises two hood hinges, and wherein all of the hood and cover body hinges have pivot axes that are collinear.

5. The apparatus of claim 1, wherein a releasable latch extends from the bottom side of the automobile hood for accepting and retaining the cover body at a fixed distance from the hood.

6. A method of displacing an engine cover that is mounted on an automobile between a hood that is pivotably mounted to the automobile by at least one hood hinge and an engine, the method comprising pivoting the hood away from the engine about said at least one hood hinge to an open hood position, and then pivoting the engine cover away from the engine about at least one engine cover hinge that pivotably attaches the engine cover to the automobile.

7. The method of claim 6, further comprising the step of attaching at least one side of the engine cover to an underside of the hood after pivoting the engine cover away from the engine.

8. The method in accordance with claim 7, further comprising detaching the engine cover from the hood, pivoting the engine cover toward the engine about said at least one engine cover body hinge, and then pivoting the hood about said at least one hood hinge to a closed hood position.
